(19) United States
(12) Patent Application Publication
(10) Pub. No.: US 2014/0188538 A1
(43) Pub. Date: Jul. 3, 2014

(54) SKILL UPDATE BASED WORK ASSIGNMENT

(71) Applicant: International Business Machines Corporation, Armonk, NY (US)

(72) Inventors: Gargi B. Dasgupta, Gurgaon (IN); Nirmit V. Desai, Bangalore (IN); Yixin Diao, White Plains, NY (US); Aliza R. Heching, Bronx, NY (US)

(73) Assignee: International Business Machines Corporation, Armonk, NY (US)

(21) Appl. No.: 14/010,782

(22) Filed: Aug. 27, 2013

Related U.S. Application Data
(63) Continuation of application No. 13/732,785, filed on Jan. 2, 2013.

(51) Int. Cl. G06Q 10/06

(52) U.S. Cl. CPC G06Q 10/063112
USPC 705/7.14

(57) ABSTRACT

Skill update based work assignment in one aspect may comprise receiving a worker set identifying a list of workers, current skills associated with the worker set, required skills associated with a set of tickets; classifying the current skills and the required skills to find worker target skills; calculating for each of the workers in the worker set, a worker's updated skill should the worker be assigned to and work on one or more of the set of tickets; and assigning one or more of the set of tickets to one or more of the workers in the worker set whose current skills enable resolving the set of tickets within a predetermined criterion, and based on whether one or more of the workers' updated skills meet the worker target skills.

### CROSS-REFERENCE TO RELATED APPLICATIONS

This application is a continuation of U.S. Ser. No. 13/732,785, filed on Jan. 2, 2013, the entire content and disclosure of which is incorporated herein by reference.

### FIELD

The present application relates generally to computers, and computer applications, information technology system services, and more particularly to skill update based work assignment.

### BACKGROUND

Every service worker in a service system has service time associated with the work he or she performs. This is referred to as the effort of the worker in the present disclosure. Currently, it is assumed that this service time is a function of the complexity and the severity of the work or a function of the type of work, and remains constant during the tenure of the worker in the pool. However, in view of continual improvements, it becomes necessary to up-skill service agents and to improve the skill matrix of the system and/or the service delivery team. Cross-training plans that exist today are expensive and time-consuming and can only happen when the service delivery team's workload is low.

### BRIEF SUMMARY

A method for work assigning, in one aspect, may comprise receiving a worker set identifying a list of workers, current skills associated with the worker set, required skills associated with a set of tickets, the required skills representing skills needed to resolve one or more tickets in the set of tickets. The method may also comprise classifying the current skills and the required skills to find worker target skills that can be accomplished within an acceptable length of training time. The method may further comprise calculating for each of the workers in the worker set, a worker's updated skill should the worker be assigned to and work on one or more of the set of tickets. The method may also comprise assigning one or more of the set of tickets to one or more of the workers in the worker set whose current skills enable resolving the set of tickets within a predetermined criterion, and based on whether one or more of the workers' updated skills meet the worker target skills.

A system for assigning work, in one aspect, may comprise a skill classifier operable to execute on a processor and further operable to receive a worker set identifying a list of workers, current skills associated with the worker set, required skills associated with a set of tickets, the required skills representing skills needed to resolve one or more tickets in the set of tickets, the skill classifier further operable to classify the current skills and the required skills to find worker target skills that can be accomplished within an acceptable length of training time. A skill calculator may be operable to calculate, for each of the workers in the worker set, a worker's updated skill should the worker be assigned to and work on one or more of the set of tickets. A skill matcher may be operable to assign one or more of the set of tickets to one or more of the workers in the worker set whose current skills enable resolving the set of tickets within a predetermined criterion, and based on whether one or more of the workers' updated skills meet the worker target skills.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 shows an example of current and desired skills in the account dimension in one embodiment of the present disclosure.

FIG. 2A shows an example of a skill matrix based on skill levels and tools.

FIG. 2B shows an example of a skill matrix based on sill levels and accounts.

FIG. 3 shows an example of worker skill matrix in one embodiment of the present disclosure.

FIG. 4 is a flow diagram illustrating a method of the present disclosure in one embodiment.

FIG. 5 is a system diagram illustrating a dispatching and up-skilling component of the present disclosure in one embodiment with input and output flow.

FIG. 6 illustrates a dispatching and up-skilling component of the present disclosure in more detail in one embodiment.

FIG. 7 illustrates a schematic of an example computer or processing system that may implement the system in one embodiment of the present disclosure.

### DETAILED DESCRIPTION

A method and system are disclosed for classifying the skills needed by the workers in a service system (e.g. an organization or entity with workers or agents, and the processes that drive service interactions, e.g., so that the outcomes meet customer expectations), e.g., such that business objectives of the service system are satisfied, and assigning a ticket (a recorded problem presented for resolution or a service request) to the worker in the system, e.g., such that the skills of the worker that get updated is the best possible one for the system given a target set of skills to achieve. A work assignment methodology in one embodiment of the present disclosure takes into account business constraints of the service system (e.g., service level agreements (SLAs)) and with a goal or target to increasing the assigned worker's skills Briefly an SLA is a contract that specifies or defines the level of service to be provided by a party to another.

A work assignment methodology in one embodiment of the present disclosure may assign a set of tickets to workers in the system (available workers) such that the worker skills get changed to a target skill matrix in the shortest possible time. A target skill matrix may specify a level of skill desired to be possessed by a worker in one or more skill areas (also referred to as domain). A methodology of the present disclosure further may update the skills of a worker based on the work assigned to the work. In one embodiment of the present disclosure, the problem of work assignment policy that achieves the target skills in the shortest time may be formulated as a constrained stochastic shortest path (CSSP).

Skill Domains and Levels:

Skills are defined relative to domains of knowledge and know-how, e.g., databases, software engagement, and operating systems. These domains are not entirely independent, e.g., a skill in databases implies a skill in computer science. In general, the relationships among the domains form a specialization hierarchy, i.e., software engineering is a specialized domain of computer science. In services industry, skill domains can be represented by accounts, tools, worktypes, and/or others. A worker may have skills in different customer accounts, in different tools used by customers and in different types of work. Consider two customer accounts accA and accB, two tools tool1 and tool2 and two different work or worktypes like problem ticket resolution and change execution. A worker's skill in terms of domains could be expressed as: {accA, accB, tool1, problem}, while another worker could be skilled as following: {accB, tool1, tool2, problem, change}.

An agent (also referred to as a worker) may have a depth of skill in a domain, called skill level, that is different from the depth of skill the agent has in another domain. Intuitively, the skill level may correspond to the amount of experience the agent is able to call upon and apply at a given point in time. Assume 3 levels of skill, e.g., basic, advanced and expert. A worker's skill in terms of domains and levels may then be expressed as {accA:advanced, accB:basic, tool1:expert, problem:expert}.

Skill Update: Skills can be developed or decayed. Skill development depends, e.g., on the frequency of skill use and the recency of use. Thus, in services skill development is dependent on the tickets assigned to workers. Thus a worker with the skill matrix of {accA:advanced, accB:basic, tool1:expert, problem:expert} can move to {accA:advanced, accB:advanced, tool1:expert, problem:expert} when a lot of advanced level work for customer accB gets assigned to that worker. This will ultimately move the worker's skill from basic to advanced level in accB. Thus work assignment can directly affect skill development. Similarly if a certain type of work is not assigned to a worker for a long time, the worker's skill may decay.

Service Times: However, when advanced work for accB gets assigned to the worker, the worker may initially take longer time than any other advanced user. This is because the skill gap between the worker's current level and the assigned work. Thus, when work assignment is done for the purpose of developing skills in one or more domains or levels, service times usually are longer. For example, less experienced people become trained on-the-job by doing higher level of work. However, eventually with practice, when the worker has worked on the job multiple times, the service times will usually get shorter. Thus, service time of a worker depends on the skill gap between the current skill as well as the skill required in the work, as well as the number of times the worker has done this work before.

We now define the skill update problem based work assignment for a service system.

Given a service system (or a service organization) with a current skill-set of workers and where the target skill state of each of the workers is also known, the methodology of the present disclosure in one embodiment finds the work assignment such that business objectives are met overall and the transition time from current to target skill state is minimized.

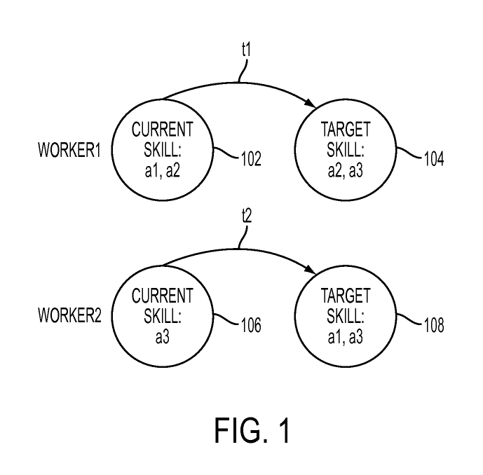

FIG. 1 shows an example of current and desired skills in the account dimension in one embodiment of the present disclosure. Item at 102 represents Worker1's current skills (a1, a2). Item at 104 represents Worker1's target skills (a2, a3), for example, those that Worker1 desires to or should have or gain after a period of time. Similarly, item at 106 represents Worker2's current skills (a3). Item at 108 represents Worker2's target skills (a1, a3), for example, those that Worker2 desires to or should have or gain after a period of time.

For instance, let t1 be the time to up-skill Worker1 to skills a2 and a3, and t2 be the time to up-skill worker2 to skills a1, a3. An objective function may be: minimize(max(t1,t2)). t1 and t2 depend on how quickly the familiarity of the workers with the target skills grows or increases. The more the tickets of this account are assigned, the quicker the up-skill. The method of increasing familiarity with a target skill may be the rate at which tickets associated with the target skill are assigned to a worker, e.g., the rate at which tickets of a3 (e.g., problem tickets needing a3 skill to resolve) is assigned to Worker1 whose target skill includes a3. However when up-skilling is done via work assignment, service times are initially longer. This causes the risk of violating SLAs. To make sure the business objectives of SLAs are not violated (e.g., the SLAs for this account are not violated), the workload arrivals need to be considered, and the work assignment for up-skilling needs to be done when the risk of violating SLAs is minimal. This makes the problem non-trivial.

The present disclosure presents both online and offline methodologies. In an online methodology, given a ticket which requires one or more skills, and the current and target skill matrices of all workers in a pool, a methodology in one embodiment of the present disclosure may find the assignment of the ticket to a worker that achieves the maximum benefit while maintaining contractual SLAs. Benefit can be defined as the distance from the target skill matrix.

In an offline methodology, given an arrival pattern of tickets <t,s>, where each ticket requires one or more particular skills, and a current and target skill matrices of all workers in a pool, a methodology in one embodiment of the present disclosure may find the assignment of the tickets <t,s> to the worker set W, e.g., t1,s1->w3, t2,s1->w2, t3,s2->w2, such that the target skill matrix is achieved in the shortest possible time while maintaining contractual SLAs. Briefly, referring to the notations used in this paragraph, t refers to ticket, s refers to skill, w refers to worker.

In one embodiment of a methodology of the present disclosure, up-skilling and dispatching are integrated. For example, skills of a person are dynamically updated based on a need to upgrade or downgrade a skill and also based on how often (frequency) the person has had to use the skill and how recently (recency). The methodology of the present disclosure in one embodiment may provide for lower costs of up-skilling and work toward finding continual efficiencies in service systems.

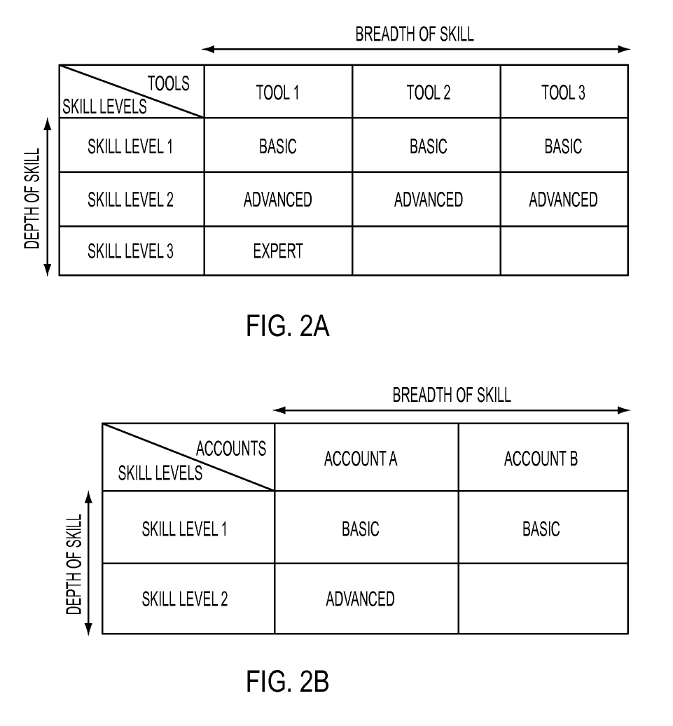

FIG. 2A shows an example of a skill matrix based on skill levels and tools. Tools may be software tools, hardware tools, equipments, and others. Skill level1 may represent basic level, skill level2 may represent advanced level, and skill level3 may represent expert level. Other categorizations of skills are possible.

FIG. 2B shows an example of a skill matrix based on skill levels and accounts. Accounts may be service accounts, customer accounts and/or others. Similar to FIG. 2A, skill level1 may be represent basic level, skill level2 may represent advanced level, and skill level3 may represent expert level. Other categorizations of skills are possible.

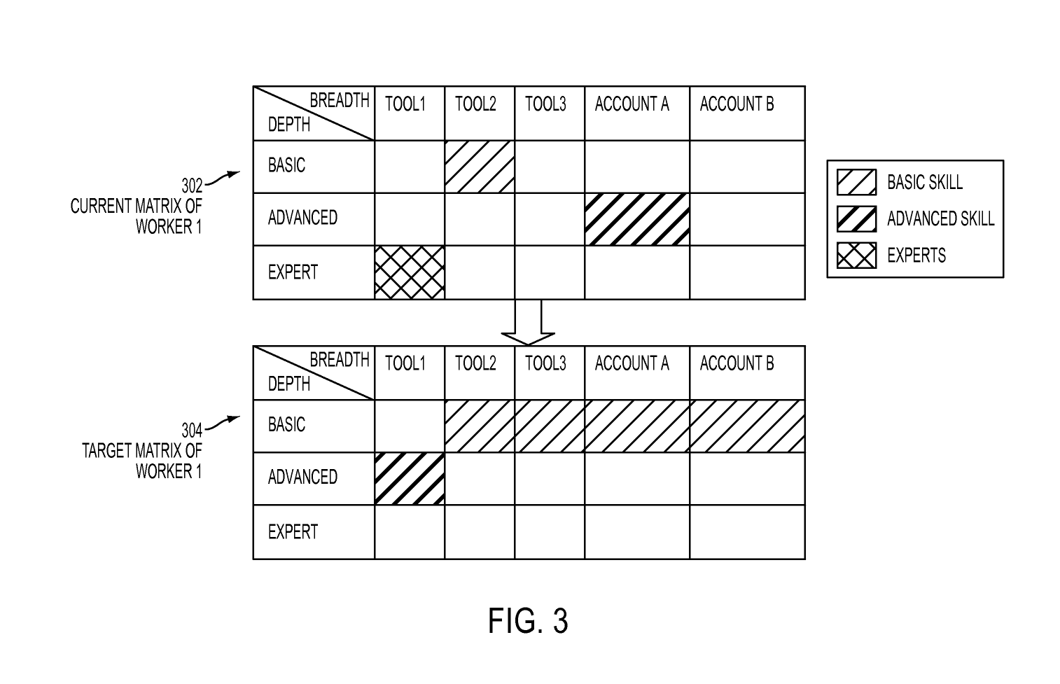

FIG. 3 shows an example of worker's current and target skill matrix in one embodiment of the present disclosure. Tickets, e.g., refer to logged or reported problems or presented for resolution or another service request. Tickets require skills to solve them, e.g.:

Ticket 1→Account B, Tool 3; (to resolve Ticket 1, knowledge or skills in Account B and Tool 3 may be needed)

Ticket 2→Account B, Tool 1; (to resolve Ticket 2, knowledge or skills in Account B and Tool 1 may be needed)

Ticket 3→Account A, Tool 2; (to resolve Ticket 3, knowledge or skills in Account A and Tool 2 may be needed)

The following describes ticket assignment in one embodiment of the present disclosure. Referring to FIG. 3, Worker 1 has skills in Tool 1, Tool2 and Account A. Specifically, Worker 1 has basic skill in Tool 2, advanced skill in Account A and expert skill in Tool 1. Worker 1's target skill set may be having basic skills in Tool 2, Tool 3, Account A and Account B, and advanced skill in Tool 1.

Assume, e.g., that assignment of any of the tickets to Worker 1 does not breach the SLA. If Ticket 3 is assigned to Worker 1, then his skills does not change in breadth (since Ticket 3 requires skills in Account A and Tool 2, which Worker 1 currently has according to the current matrix 302 of Worker 1), but may change in depth along account and tool dimensions (by gaining further knowledge or skill by the experience of working on those account and tool).

If Ticket 2 is assigned to Worker 1, then the worker's breadth of skills changes along the account dimension (since Ticket 2 requires skill in Account B, which the worker does not currently have). But his tool knowledge only changes in depth (since Ticket 2 requires skill in Tool 1, which the worker currently has).

If Ticket 1 is assigned to Worker 1, then his breadth of skills changes along both dimensions account and tool (since Ticket 1 requires skill in Account A and Tool 3, which the worker currently does not have, but would gain by experience of working on the problems associated with those account and tool).

Given the target matrix of the worker 304, which includes skills in Tool 1, Tool 2, Tool 3, Account A and Account B, Ticket1 is the best assignment in this example case. Skills may get updated to basic in Account B and Tool 3, e.g., if conditions are satisfied (e.g., if enough work for account B and tool 3 are assigned to the worker and the service times have reduced with time and practice).

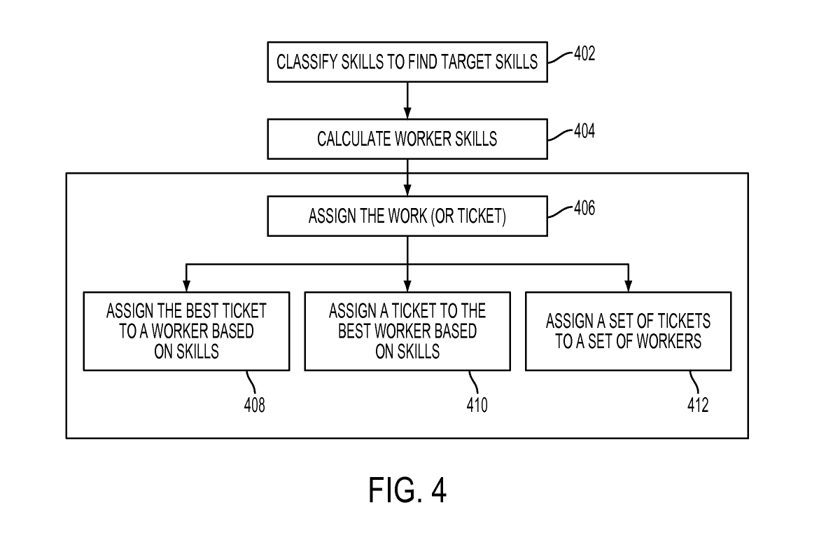

FIG. 4 is a flow diagram illustrating a method of the present disclosure in one embodiment. An automated methodology for achieving such ticket assignment may comprise, at 402, classifying skills to find target skills, e.g., while satisfying business constraints. In this step, the set of available skills and required skills are classified and a target skill matrix is computed. Required skills refer to those needed to provide a service or problem resolution or the like.

The methodology may also comprise at 404, calculating worker skills. The methodology may also comprise at 406, assigning the work (or ticket), e.g., subject to the business constraints. Assigning the work may comprise assigning the best ticket to a worker based on skills (408), assigning a ticket to the best worker based on skills (410), and/or assigning a set of tickets to a set of workers (412).

Classifying skills (e.g., shown at 402) may provide for skill classification that finds the target skills that are needed for a set of workers when the work that is expected to come in is known. For example, an embodiment of the present disclosure may solve the skill classification problem in the following manner. Let the current skill matrix of the workers be S. Let the business constraints that need to be satisfied be B. Let the set of tickets expected to come in (e.g., from forecast or from history of a period duration (e.g., 6 months to 1 year) be T. From forecasting or from history of tickets, for each ticket <t>, plot a histogram of the number of tickets seen versus types of skills required for them.

Now start with an initial solution representing the best case scenario of skilling everyone to the highest level. Estimate the training time required to get to this highest level, given the current skill matrix S. Let this be the upper bound U_{B}. U_{B} should meet business objectives B. However, in cases where U_{B} is lengthy (in time duration) and not acceptable in length (e.g., whether acceptable may be defined, e.g., by a business), then start with a different solution where the training time meets the business objectives and the training time is acceptable. For example, let the skill domains be defined across two accounts accA and accB and two tools Tool1 and Tool2. Let the skill levels be defined, e.g., as Basic, Advanced and Expert. So the initial solution may have everyone trained in Expert level of both accounts and both tools. But the training time may be 1 year which is not acceptable. So start with an initial solution where 70% of the people are trained in expert level in the accA and 30% in expert level of accB, while 60% are trained at expert level in tool1 and 40% at expert level in toolB. This brings training time down to two month which is acceptable upper bound. In the next steps, the methodology of the present disclosure in one embodiment classifies target skills further so that the training time goes down to 1 month. Let this be the lower bound U_{R}.

For instance, next, identify the lowest frequency bucket, i.e., the skill bucket which sees the lowest number of tickets. Move by 1, a skill requirement in the lowest frequency bucket to immediately next lower skill level (e.g., utilizing the histogram and buckets of the histogram). For example, let the lowest frequency bucket be a combination of accA and tool 1. And in the initial solution there are 7 workers trained in the expert level in that skill Reduce that bucket by 1. Use existing tools to estimate if this configuration can meet business SLA B. If yes, estimate the training time required U′_{R}. Continue iterating till this is acceptable at U_{R}. The corresponding S′ is the target skill matrix. Generally, this algorithm implies, for the highest frequency buckets, skills are needed in the highest level; For the lower frequency buckets, skills in the lower level may be manageable.

Skill Updation Algorithm:

A method of calculating worker skills at 404 may comprise the following processing:

As a worker completes the worker's task the worker's skill needs to be updated according to the equation: Let bₚ be the current possessed skill and alpha be the skill gain factor.

bₚ=bₚ+alpha*bₚ (Equation 1)

where alpha is the skill gain factor.
In one embodiment alpha can be defined as the following:

alpha=(gap-learning-rate−forgetting-factor)*log(1+skill-gap) (Equation 2)

Let gap-learning rate of a worker be defined as the rate (in the range 0-1) at which a worker learns when higher skilled work is assigned to the worker. This gap learning rate depends on (a) how many higher skilled items the worker has worked on and (b) how much time the worker has spent on higher skill work. A worker having a higher gap-learning rate should experience higher gain in skill, hence the factor gap-learning-rate. Also, when the skill gap is bigger, the agent has a higher opportunity to learn and experiences higher skill gain, hence the factor skill-gap. One learns more initially in a new job than one does after being there for a while. The forgetting factor (in the range 0-1) denotes the forgetting a worker experiences due to long breaks in work assignment. Note that as forgetting factor tends to gap-learning rate, i.e., the forgetting due to breaks becomes higher, the net skill gain becomes smaller. When forgetting is more than the gap learning rate, the agent starts losing skill. On a technical note, because by is discrete it changes in a step-wise manner when the right hand side of the equation 1 is enough to move to the next discrete level of skill.

Service Time Computing:

The service times of a worker working on a ticket depends on the learning and forgetting rates. Let T1 be the function that returns the expected time to complete a work for the first time, a task from a skill bin b. Let Tn be the function that returns the expected time to complete an n-th repetition of a task from a skill bin. Here, a task is a repeat of another task if both the tasks require skills that belong to the same skill bin. Then, the time taken to complete a task is given as follows.

Tn(b)=T1(b)n^{-(gap-learning-rate-forgetting-factor)} (Equation 3)

A method for work assignment subject to business constraints at 406, in one aspect, may comprise computing the target time of the ticket to complete (or resolution) within the SLA, and finding the set of workers whose current skill (and hence service times) will enable the ticket completion within the SLA.

The following is an algorithm that may be used for work assignment.

Assign:

For each ticket,

Compute the target time of the ticket to complete within the SLA;

Find the set of workers whose current skill (and hence service times) will enable the ticket completion within the SLA.

AssignSkillA:

Assigning the Best Ticket to a Worker: In one embodiment of the methodology of the present disclosure, assigning work may comprise at 408 assigning the best ticket to a worker based on skills. For example, a ticket that is determined to best produce the desired target skill for a worker, should the worker work on the ticket, is assigned to the worker. Assigning the best ticket to a worker based on skills may comprise computing a score for each ticket based on how the skills of a worker will be updated, given that the SLA or one or more predetermined criteria is satisfied. To compute the score, for example, the method may comprise computing the updated skill level of the worker for each item based on the Skill Updation Algorithm, and if there are multiple updates, computing the sum of the updates for each dimension.

Assigning the best ticket to a worker based on skills may also comprise assigning the ticket to the worker who has the maximum sum across all dimensions. Assigning the best ticket to a worker based on skills may further comprise re-updating skills post assignment (after the assignment).

The following algorithm, e.g., may be utilized for assigning the best ticket to a worker based on skills:

1. Consider a set of all tickets that can be assigned.

2. Compute the score of each ticket based on how the skills of a worker will be updated, given that the SLA (or another criteria) is satisfied. Use Skill Updation Algorithm to get the updated skill. For example:
2a. Compute the updated skill level of the worker for each ticket item.
2b. If multiple skills are updated, compute the sum of the updates for each dimension.

3. Assign the ticket which has the maximum score across all dimensions, since it represents the maximum update to the worker's skill.

4. Re-update skills post assignment via Skill Updation Algorithm.

AssignSkillB:

Assigning a Ticket to Best Worker: In another embodiment, assigning work may comprise at 410 assigning a ticket to the best worker based on skills Assigning a ticket to the best worker based on skills may comprise computing the current skills of the workers. Current skills of the workers may be computed as described above with reference to FIG. 4 at 404. Assigning a ticket to the best worker based on skills may also comprise computing the rank of each available worker based on how their skills will be updated, given that the SLA (or one or more predetermined criteria or condition) is satisfied. For example, computing the rank may comprise computing the updated skill level of a worker for each item, where distance d=Target Skill−Updated Skill for each item, and ranking the agents (workers) based on the minimum computed distance, min(distance). Assigning a ticket to the best worker based on skills may also comprise assigning the ticket to the agent with the highest rank (smallest distance d), and taking the next ticket in the queue.

AssignSkillC

Assigning a set of tickets to a set of worker: Still yet in another embodiment, assigning work may comprise at 412 assigning a set of tickets to a set of workers. The following describes assigning a set of tickets to a set of workers. Let the entire time history be divided into t intervals. Assume a dispatcher that dispatches from a single queue. Each worker maintains a local queue. Find the feasible set of workers, e.g., using the above-described Assign method, to whom the work can be assigned with reasonable probability of not violating business constraints. Push tickets from central dispatcher queue to one among the feasible set of workers. For each discrete time interval t, for each ticket with timestamp t, push on the best worker's queue using, e.g., the method described at 410 (AssignSkillB), until time t ends. The following describes a pull method at each worker queue. For each worker, as the worker becomes available, pull the best ticket from the queue to work on using, e.g., the method described at 408 (AssignSkillA), until all tickets in the queue are completed. Continue push and pull till t ends or there are no more tickets.

A pseudo-algorithm for the above-described AssignSkillC method may be as follows:

1. Compute the current skills of the workers.
2. Compute the rank of each available worker based on how their skills will be updated, given that the SLA is satisfied. A higher rank is given to a worker whose skill level is updated more.
a. Compute the updated skill level for each skill domain,

Distance d=Target Skill−Updated Skill

3. Let the entire time history be divided into t intervals. Assume the Dispatcher dispatches from a single queue. Each worker maintains a local queue.
4. Find the feasible set of workers
a. subject to business constraints using Method Assign.
   5. Find the set of workers for assigning work to.
   6. Push tickets from Central Dispatcher Queue
a. For each discrete time interval t
b. For each ticket with timestamp t,
   i. Push on the best worker's queue using Method AssignSkillB
Until time t ends.
   7. Pull Method at each worker Queue
a. For each worker, as (s) he becomes available,
   i. Pull the best ticket from the queue to work on using Method AssignSkillA
Until all tickets in the Queue are completed.
   8. Continue Push and Pull till t ends or there are no more tickets.

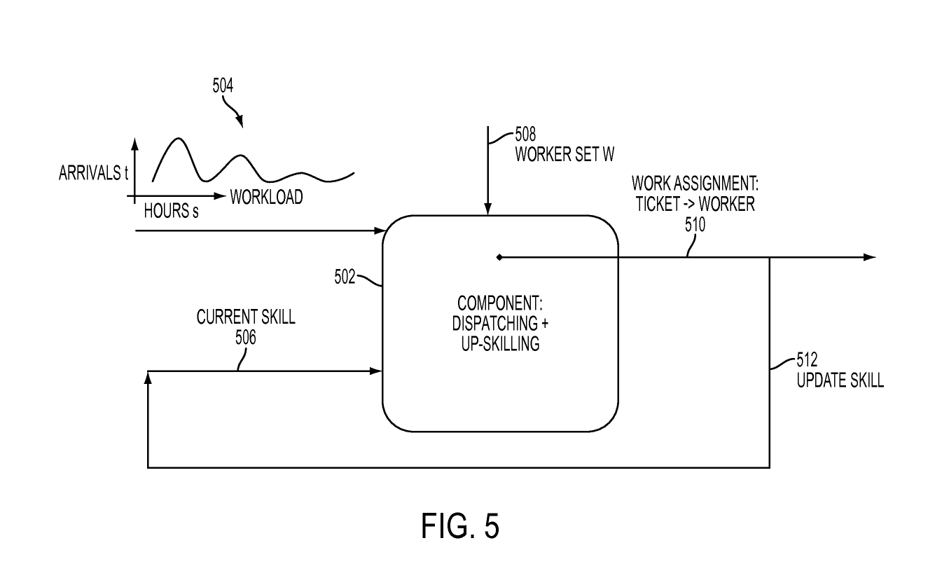

FIG. 5 is a system diagram illustrating a dispatching and up-skilling component of the present disclosure in one embodiment with input and output flow. Dispatching and up-skilling component 502 of the present disclosure in one embodiment receives workload, e.g., tickets 504 that arrive over time. At 504, the vertical axis represent number of tickets (t) that arrive and the horizontal axis represent the time, e.g., hours). Dispatching and up-skilling component 502 of the present disclosure in one embodiment also receives current skills (description thereof) 506, and set of workers W 508, identified by their identifiers. Dispatching and up-skilling component 502 of the present disclosure in one embodiment outputs work assignment 510, e.g., ticket to worker, and also updates skills specification 512.

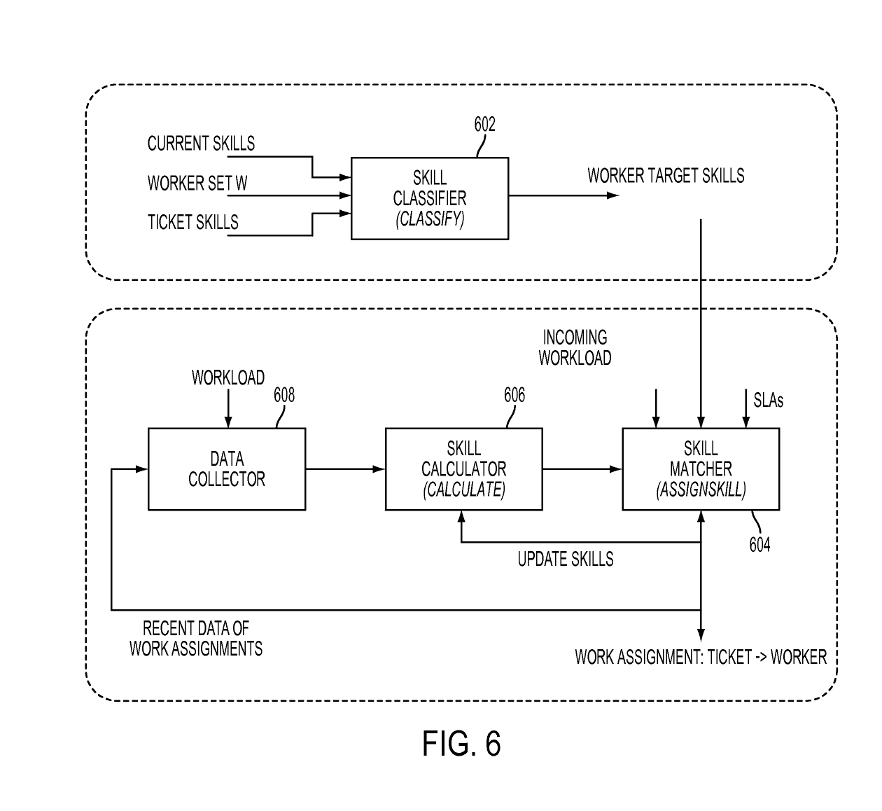

FIG. 6 illustrates a dispatching and up-skilling component of the present disclosure in more detail in one embodiment. The dispatching and up-skilling component of the present disclosure in one embodiment may comprise a skill classifier 602 that receives as input current skills of workers, worker set W, and skills required to address or resolve a ticket (e.g., problem) or the like. The skill classifier 602 outputs worker target skills, e.g., utilizing the method described with reference to FIG. 4 at 402. The output worker target skills may be used as input to a skill matcher component 604 of the present disclosure that assigns work (e.g., ticket) to worker. The skill matcher 604 receives worker target skills, incoming workload and SLAs to compute work assignment, e.g., utilizing the method described with reference to FIG. 4 at 406, e.g., one or more methods described at 408, 410, 412 in FIG. 4. A skill calculator 606 of the present disclosure calculates skill, e.g., utilizing the method described with reference to FIG. 4 at 404, with the input data received from a data collector 608 that collects workload (or tickets). Assignments determined in the skill matcher 604 are used to update skills in the skill calculator 606, and to update the recent data of work assignments in the data collector 608.

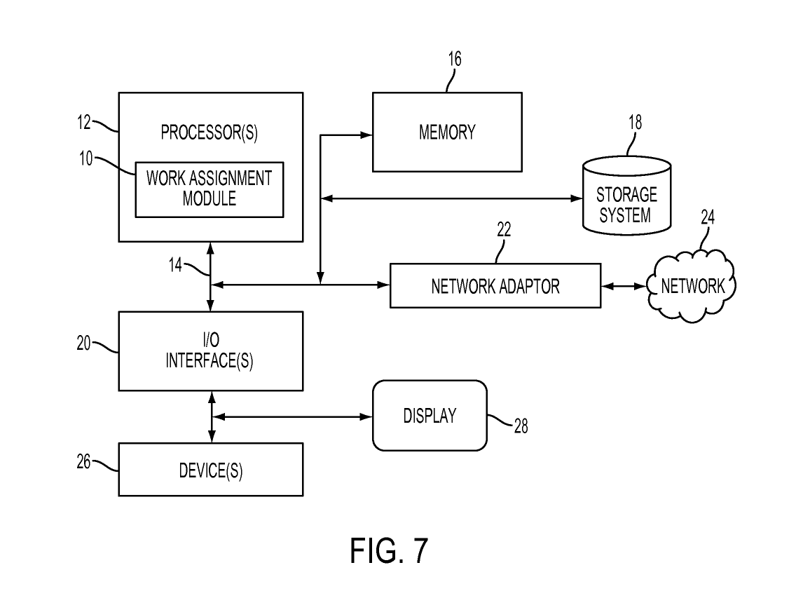

FIG. 7 illustrates a schematic of an example computer or processing system that may implement the system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a work assignment module 10 (e.g., dispatching and up-skilling module) that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer readable storage medium storing a program of instructions executable by a machine to perform a method for work assigning, comprising:
receiving a worker set identifying a list of workers, current skills associated with the worker set, required skills associated with a set of tickets, the required skills representing skills needed to resolve one or more tickets in the set of tickets;
classifying, by a processor, the current skills and the required skills to find worker target skills that can be accomplished within an acceptable length of training time;
calculating, automatically by the processor, for each of the workers in the worker set, a worker's updated skill should the worker be assigned to and work on one or more of the set of tickets; and
assigning one or more of the set of tickets to one or more of the workers in the worker set whose current skills enable resolving the set of tickets within a predetermined criterion, and based on whether one or more of the workers' updated skills meet the worker target skills.

2. The computer readable storage medium of claim 1, further comprising:
updating the worker's skill based on the assigned one or more tickets.

3. The computer readable storage medium of claim 1, wherein the assigning comprises assigning a ticket from the set of tickets that best produce the worker's target skills.

4. The computer readable storage medium of claim 3, wherein the assigning further comprises computing a score for each ticket in the set of tickets based on how the current skills of a worker in the set of workers will be updated, given the predetermined criterion is satisfied, and assigning the ticket based on the computed scored.

5. The computer readable storage medium of claim 4, wherein the score is computed across multiple skill dimensions and the ticket is assigned to a worker who has maximum sum of the computed score across the multiple skill dimensions.

6. The computer readable storage medium of claim 1, wherein the assigning comprises assigning a ticket in the set of tickets to a worker in the set of workers whose updated skill is closest to the worker target skill.

7. The computer readable storage medium of claim 6, wherein the assigning comprises computing a rank associated with each of the set of workers, the rank specifying a distance between the updated skill associated with said each of the set of workers and the worker target skill associated with said each of the set of workers, wherein the worker associated with the distance that is smallest is assigned the ticket.

8. The computer readable storage medium of claim 1, wherein the assigning comprises assigning a set of tickets to the set of workers, comprising:
pushing one or more of the set of tickets to one or more worker's queues associated with one or more of the workers based on the updated skills associated with the one or more workers; and
for each worker, pulling a ticket from the respective worker's queue that best upgrades the respective worker's skill to meet the worker target skill associated with the respective worker.

9. A system for assigning work, comprising:
a processor;
a skill classifier operable to execute on the processor and further operable to receive a worker set identifying a list of workers, current skills associated with the worker set, required skills associated with a set of tickets, the required skills representing skills needed to resolve one or more tickets in the set of tickets, the skill classifier further operable to classify the current skills and the required skills to find worker target skills that can be accomplished within an acceptable length of training time;
a skill calculator operable to calculate, for each of the workers in the worker set, a worker's updated skill should the worker be assigned to and work on one or more of the set of tickets; and
a skill matcher operable to assign one or more of the set of tickets to one or more of the workers in the worker set whose current skills enable resolving the set of tickets within a predetermined criterion, and based on whether one or more of the workers' updated skills meet the worker target skills.

10. The system of claim 9, wherein the skill calculator further updates the worker's skill based on the assigned one or more tickets.

11. The system of claim 9, wherein the skill matcher is further operable to assign a ticket from the set of tickets that best produce the worker's target skills.

12. The system of claim 11, wherein the skill calculator is further operable to compute a score for each ticket in the set of tickets based on how the current skills of each worker in the set of workers will be updated, given the predetermined criterion is satisfied, and the skill matcher is further operable to assign the said each ticket based on the computed score.

13. The system of claim 12, wherein the skill calculator is further operable to compute the score across multiple skill dimensions and the skill matcher is operable to assign said each ticket to a worker who has maximum sum of the computed score across the multiple skill dimensions.

14. The system of claim 9, wherein the skill matcher is further operable to assign a ticket in the set of tickets to a worker in the set of workers whose updated skill is closest to the worker target skill.

15. The system of claim 14, wherein the skill matcher is further operable to compute a rank associated with each of the set of workers, the rank specifying a distance between the updated skill associated with said each of the set of workers and the worker target skill associated with said each of the set of workers, wherein the worker associated with the distance that is smallest is assigned the ticket.

16. The system of claim 9, wherein the skill matcher is further operable to assign a set of tickets to the set of workers, by pushing one or more of the set of tickets to one or more worker's queues associated with one or more of the workers based on the updated skills associated with the one or more workers, and for each worker, pulling a ticket from the respective worker's queue that best upgrades the respective worker's skill to meet the worker target skill associated with the respective worker.
